(19) United States
(12) Patent Application Publication
(10) Pub. No.: US 2007/0132226 A1
(43) Pub. Date: Jun. 14, 2007

(54) INDEXING SYSTEM

(76) Inventor: Susan Clark, Bundoora (AU)

Correspondence Address: STITES & HARBISON PLLC, 1199 NORTH FAIRFAX STREET, SUITE 900, ALEXANDRIA, VA, 22314, US

(21) Appl. No.: 11/556,295

(22) Filed: Nov. 3, 2006

(30) Foreign Application Priority Data
Nov. 4, 2005 (AU) 2005906135

(51) Int. Cl. B42F 21/00

(52) U.S. Cl. 283/42; 206/424

(57) ABSTRACT

An indexing system for a book, the system comprising an enclosure for the book, the enclosure having a back wall and a top wall capable of pivoting relative to the back wall. The top wall carries a scale with a displaceable slide and the scale carries indications that correspond to specific pages in the book. The system also includes plurality of book tabs adapted to be attached to specific pages of the book. The slide is attached to at least one arm that includes a lug adapted to engage a tab. Actuation means cause the lug to move from a disengaged to an engaged position in which the lug engages the tab, whereby displacement of the slide to a selected page causes the arm and lug to be positioned adjacent a selected tab and activation of the actuation means causes the lug to assume the engaged position with the selected tab so that when the top wall is pivoted open the book is opened at the selected page.

### FIELD OF THE INVENTION

This invention relates to an indexing system particularly for use with large book.

### BACKGROUND OF THE INVENTION

There is often a problem with large reference books such as encyclopaedias, dictionaries, manuals and finding a particular chapter. For instance, the Bible is composed of 66 books, 39 in the Old Testament and 27 in the New Testament. During Bible classes or Bible study groups or even worshipping in church there is often a need to select one of the 66 books quickly. This can be a particular problem to the old and infirmed including those with impaired sight.

It is these issues that have brought about the present invention.

### SUMMARY OF THE INVENTION

According to one aspect of the present invention there is provided an indexing system for a book, the system comprising an enclosure for the book, the enclosure having a back wall and a top wall capable of pivoting relative to the back wall, the top wall carrying a scale with a displaceable slider, the scale carrying indications that correspond to specific pages in the book, a plurality of book tabs adapted to be attached to specific pages of the book, the slider being attached to at least one arm that includes a lug adapted to engage a tab, and activation means to cause the lug to move from a disengaged to an engaged position in which the lug engages the tab whereby displacement of the slide to a selected page causes the arm and lug to be positioned adjacent a selected tab and activation of the actuation means causes the lug to assume the engaged position with the selected tab so that when the top wall is pivoted open the book is opened at the selected page.

### DESCRIPTION OF THE DRAWINGS

An embodiment of the present invention will now be described by way of example only with reference to the accompanying drawings in which:

FIG. 1 is a perspective view of an enclosure incorporating an indexing system in accordance with one embodiment of the invention;

FIG. 2 is a perspective view of the enclosure supporting a book in an open position;

FIG. 3 is a perspective view showing the interaction between tabs on the book and engagement arms of the indexing system;

FIG. 4 is perspective views of four arms, slides and tabs;

FIG. 5 is a cross sectional view of the enclosure supporting a book, the book and enclosure being in a closed position;

FIG. 6 is a plan view of the top of the enclosure;

FIGS. 7a and 7b are perspective views illustrating displacement of a slide;

FIG. 8 is a cross sectional view of the enclosure illustrating engagement between an arm and a selected tab; and

FIG. 9 is a cross sectional view of the enclosure in a partially open position.

### DESCRIPTION OF THE PREFERRED EMBODIMENT

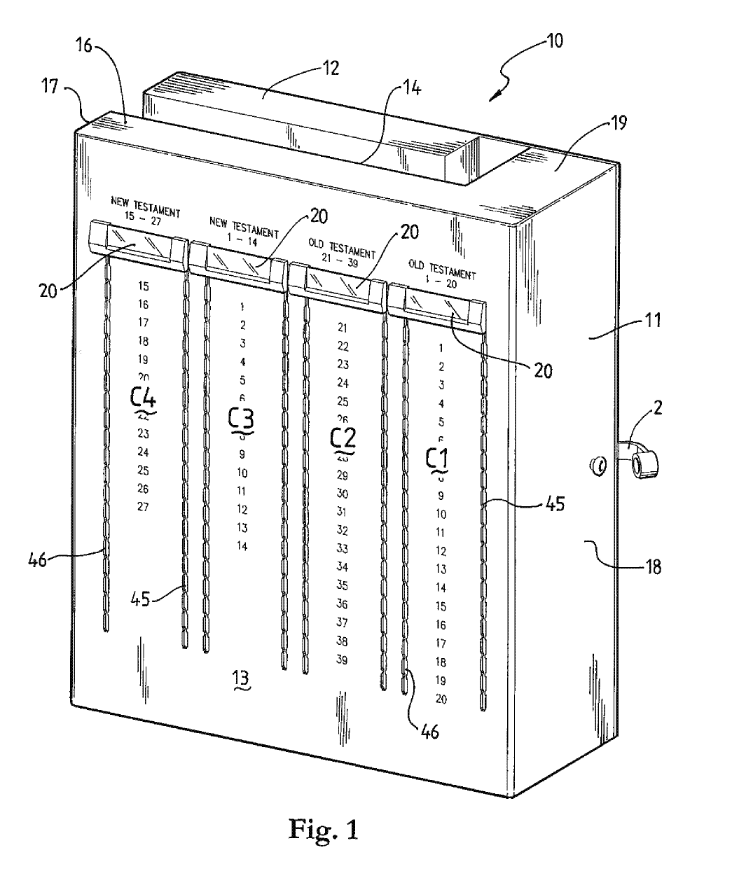

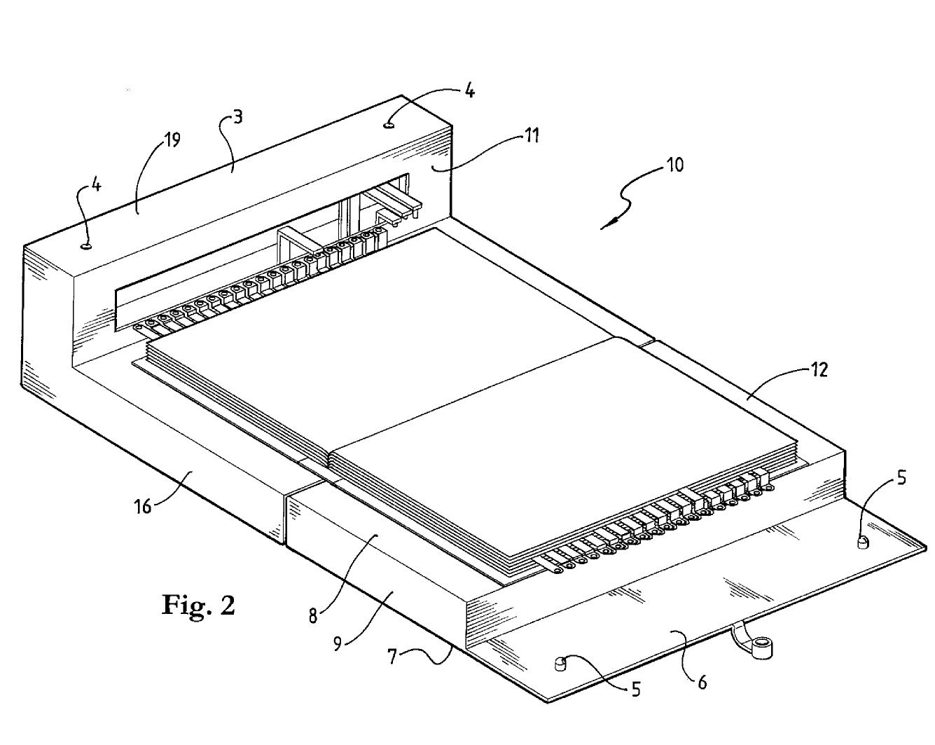

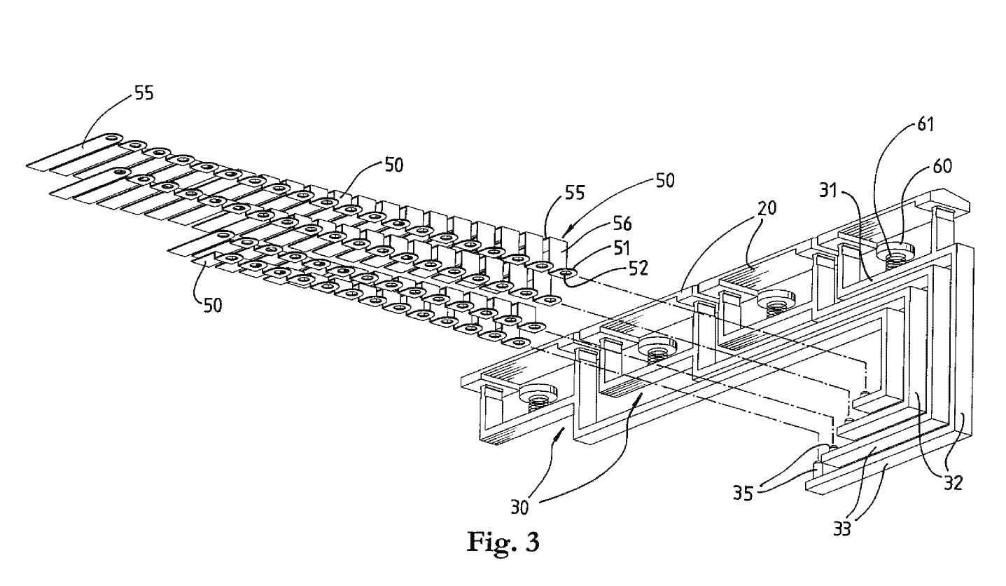

The accompanying drawings illustrate an indexing system for a large printed publication such as The Bible. The system comprises a rectangular enclosure 10 formed essentially of a top wall structure 11 that sits against a bottom wall structure 12 to define the rectangular enclosure shown in FIG. 1. The top wall structure 11 has a top face 13 that is preferably manufactured of plastics with a bottom face 14 spaced behind the top face to define an enclosure 16. The top and bottom faces are preferably made of plastics in solid colour but may be made to be transparent. A back wall 17 joins the top and bottom faces 13, 14. The top wall structure 11 also has a front wall 18 that extends to the base of the enclosure as shown in FIGS. 1 and 2 to define a second rectangular enclosure 19. The bottom wall structure 11 shown in FIG. 2 is in the form of a rectangular block 9 that has an upper face 8 spaced above the underside 7 with the block 9 terminating in a forwardly projecting rectangular flange 6 that has two upstanding spaced lugs 5 to engage in apertures 4 in the underside 3 of the forward enclosure 19 on the top wall structure 11. It is understood that while two lugs 5 are illustrated, more lugs may be used in practice.

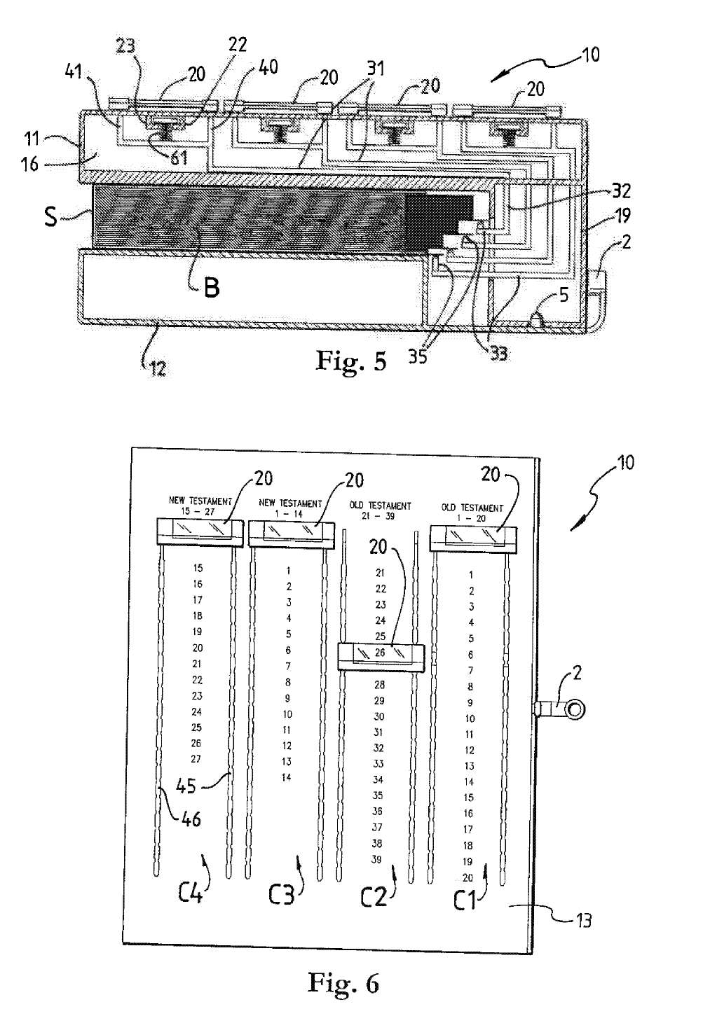

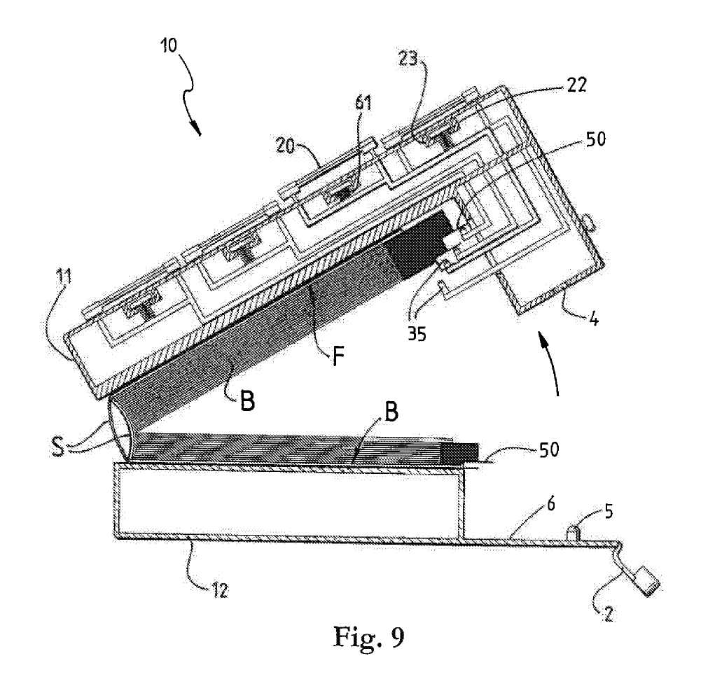

Thus, as shown in FIG. 9, when the enclosure 10 is closed, the top wall structure 11 pivots down onto the bottom wall structure 12 so the lugs 5 extend into the apertures 4. A centrally positioned locking tab 2 is positioned to interconnect the bottom structure 12 to the top structure 11 to hold the enclosure 10 in a closed and locked position as shown in FIG. 5.

The interior of the top and bottom wall structures 11, 12 define a rectangular enclosure that can accommodate a comparatively thick book such as a bible. As shown in FIG. 9, the book (B) comprises a hard front cover (F) joined to a hard back cover (B) by a spine (S). The pages of the book are secured to the spine (S) and extend forwardly to define a front edge. The interior surfaces of the top and bottom structures 11, 12 are designed to accommodate the hard front and rear covers of the book and it is understood that a number of mechanisms may be incorporated to secure the book to the enclosure 10 such as profiled cut outs that accommodate the hard surfaces of the front and rear of the book and elastic or plastics sleeves into which the front or rear of the book (B) can be slid to ensure that the book is secured between the two halves 11, 12 of the enclosure 10.

In the example illustrated in the drawings, the indexing system is specifically designed for use with the Bible. The Bible is divided into 66 books and the indexing system is adapted so that once a book has been selected, the Bible is opened to the first page of that book. A slide 20 is arranged to be displaceable about parallel slide rails 22, 23 attached to the underside of the top face 13 of the enclosure 10 and movement of the slide 21 on the rails 22, 23 effects the selection of the desired book. However, since there are 66 books, it is not practical to have a vertical array of 66 books on one pair of rails so the indexing system has been split into two rail sets in four vertically spaced columns C1, C2, C3, C4. The right hand column C1 represents books 1 to 20 of the Old Testament. The second column C2 represents books 21 to 39 of the Old Testament. The third column C3 represents books 1 to 14 of the New Testament and the fourth column C4 represents books 15 to 27 of the New Testament.

The mechanism that interconnects the pointer 20 on the rails 22, 23 with the desired book is the same for each column and thus for ease of description a single column is described though it is understood that this is then duplicated a further three times to provide the four columns described above.

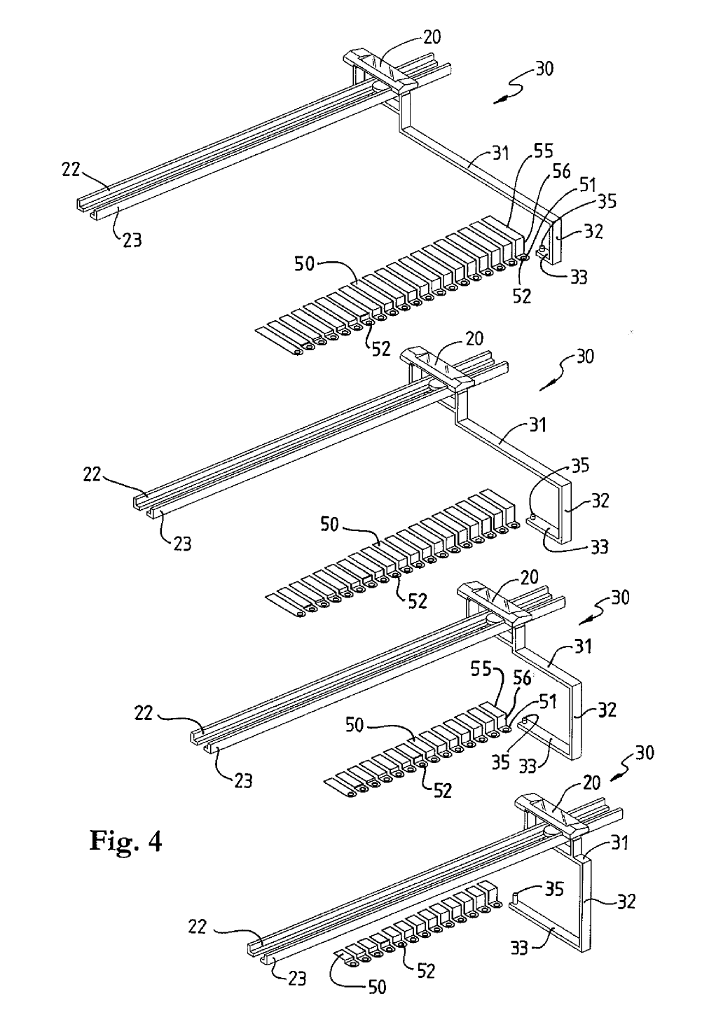

The last page of each book of the Bible has a book mark or tab 50 positioned on its front edge. The tab 50 as shown in FIG. 6 is adhesively secured to the edge of the page and has a forwardly projection flange 51 terminating in an eyelet 52. The tabs 50 are tabulated in a staggered fashion down the books of the Bible to provide four rows of tabs 50 as shown in FIG. 4.

The top face 13 of the enclosure has four slides 25 that can be displaceable up and down the rails 22, 23 as shown in FIG. 5. Each slide 20 is connected to a rectilinear arm arrangement 30 that has a main elongate beam 31 joined mutually perpendicularly to a side flange 32 that is, in turn, perpendicularly attached to a return 33. The return 33 is in turn coupled to an upturned lug 35 that is arranged to engage the eyelet 52 of the tab 50. Thus displacement of the slide 20 along the rails 22, 23 moves the arm assembly 30 and lug 35 to the desired position so that the lug 35 engages in the eyelet 52 in the selected bookmark or tab 52.

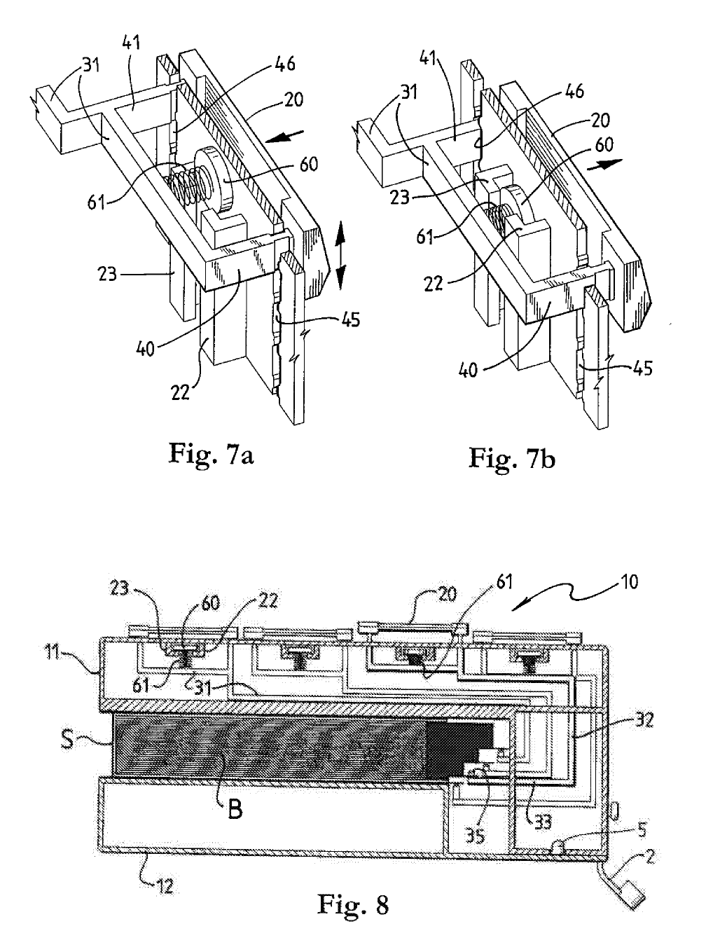

The elongate beam 31 of each arm 30 extends across the page of the book from the slide 20 to the front edge of the book (B). As shown in FIGS. 7a and 7b a pair of seat members 40, 41 project upwardly from the end of the beam 31 to be engaged by the underside of the slide 20.

Each slide 20 comprises a transparent rectangular plate that sits on the top face 13 of the enclosure. The plate 20 is interconnected to grooved seats 40, 41 on the arm through parallel slots 45, 46 in the top face 13. Each rail 22, 23 is an L shaped plastics strip that is secured to the rear of the top face 13 to define a vertical channel in which a disc 60 is a sliding fit. The disc 60 is attached to the end of the beam 13 via a spring 61. Each slot 22, 23 has nodules 48 that runs down the column. In the neutral position shown in FIG. 7a the spring 61 holds the slide 20 against the top face 13 with the grooves seats 40, 41 engaging the slots 45, 46. The lugs 35 and tabs 50 are disengaged and the slides 20 locked against movement. To release the slides 20 and engage the lugs 35 and tabs 50 the grooved seats 40, 41 are released from the slots 45, 46 and the slide 20 moved to the selected book at which the spring 61 urges the slide 20 and arm 30 upwardly thus engaging the lug 35 with the eyelet 52 on the tab 50. This position is shown in FIG. 7b.

As shown with particular reference to FIGS. 4 and 8, since the columns C1, C2, C3, C4 are spaced across the top face 13 and the assembly for each column is the same it can be seen that the beams 31 vary in length across the top cover and the flanges 32 in depth down the front edge. The returns 33 also vary so that, as shown in FIG. 8, all four arm assemblies 30 can be accommodated in the enclosure 10 without one arm impeding the motion of the other. The relationship between the slides 20 and the rails 22, 23 and the interconnection with the arms 30 are accommodated in the enclosure 16 defined by the underside of the top wall structure 11 and the flanges 32 and returns 33 including the engagement lugs 35 are accommodated in the enclosure 19 of the top structure 11 that is formed forward of the front edge of the book as shown in FIG. 8. The reason that the bottom structure 11 has a rectangular block 9 to raise the book above the base of the unit is to ensure that when the book is open at its middle, as shown in FIG. 2, the front (F) and rear (R) covers of the book are in substantially the same plane.

The movement of the arms 30 to engage the eyelets 52 in the tabs 50 as described with reference to FIGS. 7a and 7b provides only a small degree of vertical movement. Since there may be a large number of chapters in some of the books, if planar tabs 50 were secured to the selected pages there could be a considerable difference in height between the tab on the first chapter and the tab on the last chapter. To accommodate this change in height, it is understood, as shown in FIG. 4, that the tabs 50 could have an angled structure whereby each tab comprises a planar portion 55 that is secured to the page of the book that merges in a downwardly projecting portion 56 that in turn has extending forwardly therefrom the flange 51 with the eyelet 52. As shown in FIG. 4, this then allows the eyelets to remain in substantially the same plane whilst accommodating for the vertical spacing between chapters of the books.

Use of the indexing device is shown with particular reference to FIGS. 1, 6, 7, 8 and 9. The lock at the front is first released and then a chapter is selected which, as shown in FIG. 6, is book 45 of the Old Testament. The slide is pushed down as shown in FIG. 7a, releasing the seats 40, 41 from the nodules in the slide and allowing the slide to move down to the selected chapter. At the same time, movement of the slide has caused movement of the arm 31 so that the lug on the return of the third arm is positioned under the eyelet on the tab of the selected book. When the slide is released, the spring urges the arm upwardly so that the lug engages the tab as shown in FIG. 8. The front cover is then pivoted open using the spine of the book as a pivot and the partial pivoted position is shown in FIG. 9 where the engagement of the arm into the eyelet on the tab means that the book is opened at the selected page to finally assume the position of FIG. 2, where the selected chapter can be referenced. In order to take the pivoting load off the spine, the device may include supports. To repeat the exercise, the book is then closed, the slides are returned to the neutral position shown in FIG. 1 and the selection process repeated.

1. An indexing system for a book, the system comprising:
an enclosure for the book;
the enclosure having a back wall and a top wall capable of pivoting relative to the back wall, the top wall carrying a scale with a displaceable slide, the scale carrying indications that correspond to specific pages in the book;
a plurality of book tabs adapted to be attached to specific pages of the book;
the slide being attached to at least one arm that includes a lug adapted to engage a tab; and
actuation means to cause the lug to move from a disengaged to an engaged position in which the lug engages the tab, whereby displacement of the slide to a selected page causes the arm and lug to be positioned adjacent a selected tab and activation of the actuation means causes the lug to assume the engaged position with the selected tab so that when the top wall is pivoted open the book is opened at the selected page.

2. The indexing system according to claim 1 wherein the tabs are secured to specific pages of the book so that the tabs project forwardly from the front edge of the book.

3. The indexing system according to claim 2, wherein each arm extends across the top of the book under the top wall, down the front edge of the book, each arm including a return with the lug being positioned to extend upwardly from the return to a position adjacent and below the tabs.

4. The indexing system according to claim 3, wherein each tab has an aperture into which the lug can extend in the engaged position.

5. The indexing system according to claim 1, wherein biasing means are positioned between the slide and the arm so that downward pressure on the slide causes downward movement of the arm against the biasing means and release of the slide causes the biasing means to urge the arm upwardly so that the lug engages the tab.

6. The indexing system according to claim 5, wherein the biasing means is a spring positioned between the slide and the arm.

7. The indexing system according to claim 1, wherein the slide extends through a slot in the top wall to be connected to the arm.

8. The indexing system according to claim 7, wherein the slide is displaceable along a rail secured to the underside of the top wall.

9. The indexing system according to claim 1, wherein a plurality of slides are provided each displaceable about a separate scale, each pointer being coupled to a separate arm.

10. The indexing system according to claim 1, wherein the book is formed into four sections, each section carrying a plurality of tabs adapted to be engaged by a lug on a separate arm in turn attached to a separate slide.
